(19) United States
(12) Patent Application Publication
(10) Pub. No.: US 2003/0090035 A1
(43) Pub. Date: May 15, 2003

(54) Method of molding a panel

(76) Inventors: Steven J. Mori, Aurora (CA); Keijo J. Huotari, Fehton, MI (US); Elliott J. Straus, Akron, OH (US); Michael Brett, West Hill (CA)

Correspondence Address: Robin W Asher, Clark Hill, Suite 3500, 500 Woodward Avenue, Detroit, MI, 48226-3435, US

(21) Appl. No.: 10/258,096

(22) PCT Filed: Apr. 20, 2001
(86) PCT No.: PCT/CA01/00534

(51) Int. Cl. B29C 45/16; B29C 45/10

(52) U.S. Cl. 264/255; 425/112; 425/470

(57) ABSTRACT

A method of manufacturing a panel utilizes a first mold half (12) having a peripherally extending rib (24) and a second mold half (14). The first mold half (12) is moved relative to the second mold half (14) to define a first mold cavity with the rib extending into the first mold cavity. A first molten material (20) is injected into the first mold cavity and allowed to solidify to thereby form a notch (26) within the first solidified material (20) corresponding to the shape of the rib (24). A second mold cavity is formed which has a flow path between the first solidified material (20) and the first mold half (12) comprising a series of sharp turns which present a barrier to material flow. A second material (30) is injected into the second mold cavity and allowed to cure on the first solidified material.

### FIELD OF INVENTION

The subject invention relates to a method of manufacturing an automotive panel that has an exterior class-A finish.

### BACKGROUND OF THE INVENTION

Injection molding is well known in many industries for manufacturing a wide variety of products. The automotive industry utilizes plastic injection molding to create a number of interior and exterior trim components and other like parts, such as tonneau covers and body panels, which require an aesthetically pleasing exterior surface. The desired exterior surface is typically known as an exterior class-A finish.

Current techniques for molding large planar panels, such as the method disclosed in U.S. Pat. No. 4,910,067, can produce structurally rigid panels. However, the quality of the surface finish is usually slightly less than class-A. A separate skin, paint or coating must then be applied to the panel after removing the panel from the mold to create the class-A finish.

It would be desirable to develop a manufacturing process which creates a class-A finish during the injection molding of the part, thereby eliminating the separate manufacturing step outside of the mold.

### SUMMARY OF INVENTION

The disadvantages of the prior art may be overcome by providing a method of manufacturing a panel utilizing a first mold half having a peripherally extending rib and a second mold half. The first mold half is moved relative to the second mold half to define a first mold cavity with the rib extending into the first mold cavity. A first molten material is injected into the first mold cavity and allowed to solidify to thereby form a notch within the first solidified material corresponding to the shape of the rib. A second mold cavity is formed which has a flow path between the first solidified material and the first mold half comprising a series of sharp turns which present a barrier to material flow. A second material is injected into the second mold cavity and allowed to cure on the first solidified material.

### BRIEF DESCRIPTION OF THE DRAWINGS

Advantages of the present invention will be readily appreciated, as the same becomes better understood by reference to the following detailed description when considered in connection with the accompanying drawings wherein:

FIG. 1 is a cross-sectional side view of a molding assembly having an upper mold half and a lower mold half in accordance with the subject invention;

FIG. 2 is an enlarged fragmentary cross-sectional side view of the molding assembly with the upper and lower mold half in a completely closed position before a first injection of a first material;

FIG. 3 is an enlarged fragmentary cross-sectional side view of the molding assembly after the first injection with the upper mold half in a partially raised position;

FIG. 4 is an enlarged fragmentary cross-sectional side view of the molding assembly after a second injection of a second material;

FIG. 5 is an enlarged fragmentary cross-sectional side view of an alternative embodiment of the upper mold half;

FIG. 6 is a perspective view of a second embodiment of a molding formed utilizing the present invention;

FIG. 7 is a top plan view of the molding of FIG. 6;

FIG. 8 is a sectional view of the molding of FIG. 6 along the lines A-A; and

FIG. 9 is a sectional view of the molding of FIG. 6 along the lines B-B.

### DETAILED DESCRIPTION OF THE PREFERRED EMBODIMENT

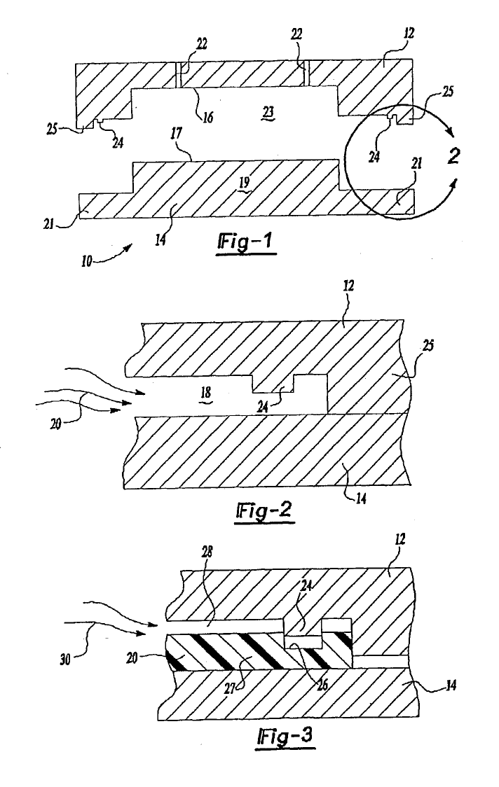

Referring to the Figures, wherein like numerals indicate like or corresponding parts throughout the several views, a molding assembly is generally shown at 10 in FIG. 1.

The molding assembly 10 includes a first mold half 12 and a second mold half 14. Both the first 12 and second 14 mold halves include an inner surface 16, 17 having a desired contour which correlates to the shape of a final molded product having a generally convex outer class-A surface (not shown).

Preferably the inner surfaces 16, 17 are configured to form an automotive panel. As appreciated, the contour of the inner surfaces 16, 17 may be of any suitable design to create a desired automotive or non-automotive molded product generally having a large planar surface.

A center plug 19 extends from the second mold half 14 that aligns with the center recess of the first mold half 12. Center plug 19 has walls that are slightly tapered to accommodate demolding. The center plug 19 has a flange 21 extending about the perimeter of the plug 19. Flange 21 extends about and is spaced from the inner surface 17.

The first mold half 12 has a recess 23 sized to receive center plug 19. Recess 23 is slightly larger than the center plug 19 such that when the mold halves 12, 14 are closed a desired gap will be maintained between surfaces 16, 17. Rib 24 extends around the recess 23. Rib 24 is spaced from the outer periphery of the first mold half 12. Abutment 25 extends about the outer periphery of the first mold half 12. Abutment 25 has a thickness which corresponds to the thickness of the desire gap between the surfaces 16, 17. Rib 24 has a thickness that is less than that of abutment 25.

To mold a product, the mold halves 12, 14 are first moved to a closed position. Abutment 25 abuts against mold half 14 forming a seal. A first molten material 20 is then injected through a plurality of apertures or gates 22, preferably in the upper mold half 12, into the first mold cavity 18 until completely filled. Alternatively, gates 22 could be located in mold half 14 in accordance with standard injection molding practice. Preferably, a plurality of gates are used and the flow of material is controlled by a technique known as sequential valve gating, which is more particularly described in U.S. Pat. No. 5,762,855. The gates are preferably positioned relative to the part to be molded in inconspicuous regions so that if a mark is created by the gate, this mark can be later covered or removed.

The first material 20 is preferably any thermoplastic material. Suitable non-limiting examples include polypropylene, polyethylene terephthalate (PET), NYLON, polycarbonate, and PCABS. Optionally, reinforcement materials such as a glass fibre, mineral filler or nanoparticle may be added to the thermoplastic. The molten material 20 solidifies or “freezes” to a rigid or semi-rigid base or substrate for the panel.

Rib 24 forms a corresponding notch 26 within the solidified first material 20 that forms flange 27 extending about the periphery of the molded part. As shown in FIGS. 1 through 4, the rib 24 has a substantially rectangular configuration. The rib 24 preferably has a trapezoidal configuration as shown in FIG. 5 (slightly exaggerated for illustration purposes) or any other suitable shape which allows the flange 27 to demold from the rib 24. As appreciated, the notch 26 formed in the flange 27 will directly correspond to the configuration of the rib 24.

As appreciated, it is desirable to have a well defined smooth exterior finish for the completed panel such that the exterior surface is aesthetically pleasing class-A finish.

Referring also to FIGS. 3 and 4, the first mold half 12 is opened slightly to create a second desired gap between the first 12 and second 14 mold halves. This gap defines a second mold cavity 28 disposed above the first material 20 for receiving a second material 30. The rib 24 and corresponding notch 26 have sharpened edges which creates a narrow channel or flow path having a series of sharp turns between the flange 27 and rib 24. The series of sharp turns presents a barrier to the flow of viscous liquids, preventing the viscous liquid from being expelled from the second mold cavity 28.

After the upper mold half 12 is raised, a second injection of the second material 30 is performed. The second material 30 forms a thin skin or coating that adheres to the solidified part. The second material 30 is preferably a light stable coating such as thermosetting polyurethane or polyester, either aliphatic or aromatic. A preferred polyurethane coating is commercially available from Omnova Solutions Inc. under the trademark GENGLAZE or STYLECOAT.

The second material 30 fills the second mold cavity 28 and extends through the narrow channel and partially spills into the notch 26 of the first material 20 as is illustrated in FIG. 4. The wave front of the second material 30, however, cannot make both turns and pass through both narrow channels. Accordingly, the flow of the uncured second material is terminated and does not escape from between the mold halves 12, 14 during the second injection process. For illustrative purposes, the gap formed between the upper 12 and lower 14 mold halves and the narrow channels are exaggerated. The preferred thickness of the skin 30 is about 3-5 thousands of an inch or approximately 0.125 mm.

During the solidification of the base, i.e., the first material 20, heat is expelled from the first material 20, which heat cures the coating 30 to the molded substrate. Optionally, the mold halves 12, 14 can be maintained at about 250° F. to enhance cross linking. Once the solidification and curing is complete, the first mold half 12 is completely opened. The molded part now has a skin defining the desired class-A finish for the panel. In addition, the panel does not require an additional painting step.

An alternative method of forming the panel is also contemplated wherein the first mold half 12 is not raised above the second mold half 14. In other words, the upper 12 and lower 14 mold halves remain in the completely closed position during the molding process. The injecting of the first material 20, along with the forming of the notch 26, occurs in the same manner as above. However, the second material 30 is injected while the mold halves 12, 14 remain closed. The first material 20 may shrink slightly during solidification and has some compressible characteristics. Hence, the injection pressure of the second material 30 will at least partially compress the first material 20 and create a small gap between the first material 20 and the first mold half 12. The small gap is analogous to the second mold cavity 28 discussed above. The rib 24 and notch 26 of the first material 20 still operate to retain the second material 30 within the upper 12 and lower 14 mold halves during the injection thereof. This method may be preferred when using a first material 20 that is compressible after an initial solidification.

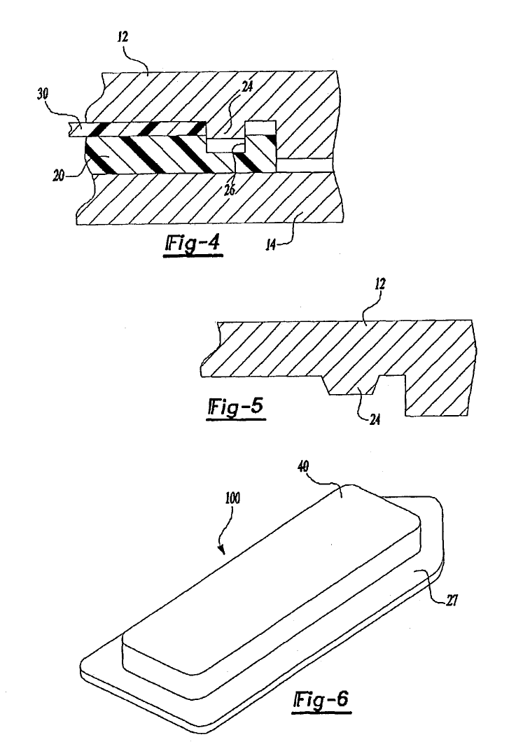

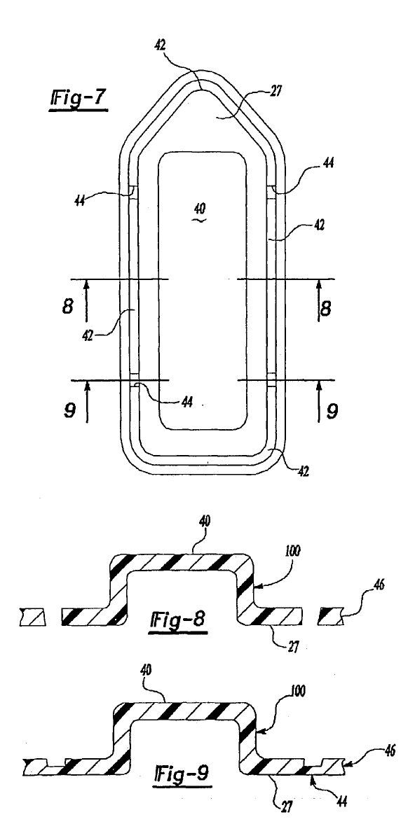

Referring to FIG. 6, a molded part 100 is illustrated. Molded part 100 generally has a convex class-A outer surface having a generally planar section 40 and a flange 27 extending about a periphery of the parent part 100. Flange 27 is preferably spaced from and extends about planar section 40.

In this embodiment, the flange 27 has a series of circumferentially extending apertures 42 separated by a series of filling webs 44. The series of apertures 42 separate the inner region of flange 27 from an outer racetrack 46. First and second mold halves 12, 14 are modified in a known manner to mold the apertures 42 by inserting walls onto either of mold half 12 or mold half 14. The portions of rib 24 are configured to extend between the walls that form apertures 42.

The molded part is formed in the manner described above. Once the formed part is removed from the mold halves 12, 14, the racetrack 46 may be removed from the parent part by cutting or shearing the webs 44. The webs 44 should have a minimal amount of the second material 30. This material can be easily removed or alternatively the webs 44 can be cut from the racetrack 46 whereupon the racetrack may be ground up into a regrind and fed back into the molding process as part of first material 20 as is known in the art.

The invention has been described in an illustrative manner, and it is to be understood that the terminology that has been used is intended to be in the nature of words of description rather than of limitation. It is now apparent to those skilled in the art that many modifications and variations of the present invention are possible in light of the above teachings. It is, therefore, to be understood that the invention may be practiced otherwise than as specifically described.

What is claimed is:

1. A method of manufacturing a molded part utilizing a first mold half having a peripherally extending rib and a second mold half, said method comprising the steps of:
closing the first mold half onto the second mold half to define a first mold cavity with said rib extending into said first mold cavity,
injecting a first molten material into the first mold cavity and allowing the first molten material to initially solidify thereby forming a notch within the solidified first material corresponding to the shape of the rib,
forming a second mold cavity having a flow path between the first solidified material and the first mold half comprising a series of sharp turns between said notch and said rib which present a barrier to material flow, and
injecting a second material into the second mold cavity and allowing the second material to cure to the first solidified material.

2. A method as claimed in claim 1 wherein said step of forming a second mold cavity includes moving the first mold half relative to the second mold half.

3. A method as claimed in claim 2 wherein said rib is continuous.

4. A method as claimed in claim 2 wherein said rib is discontinuous.

5. A method as claimed in claim 4 wherein said rib comprises a series of web portions spaced between a series of mold walls for molding a parent part and a racetrack extending about and interconnected with said parent part by a series of webs.

6. A method as claimed in claim 5 wherein said further comprises a step of removing said racetrack and web from said parent part.

7. A method as claimed in claim 6 wherein said method further comprises a step of grinding said racetrack into a regrind and adding said regrind into said first molten material.

8. A method as claimed in claim 7 wherein said parent part has a generally convex outer surface.

9. A method as claimed in claim 8 wherein said generally convex outer surface has a planar section and a flange extending about and spaced from said planar section.

10. A method as claimed in claim 9 wherein said first molten material is a thermoplastic material and said second material is a thermosetting resin.

11. A method as claimed in claim 10 wherein said thermoplastic material is selected from a group comprising polypropylene, polyethylene terephthalate (PET), NYLON, polycarbonate, and PCABS.

12. A method as claimed in claim 11 wherein said thermoplastic material is reinforced with a reinforcing material selected from a group comprising glass fibres, mineral fillers, and nanoparticles.

13. A method as claimed in claim 1 wherein said first solidified material is reduced in volume and said second cavity is formed as said second molten material is injected between the mold halves.

14. A method as claimed in claim 14 wherein said rib is continuous.

15. A method as claimed in claim 15 wherein said rib is discontinuous.

16. A method as claimed in claim 16 wherein said rib comprises a series of web portions spaced between a series of mold walls for molding a parent part and a racetrack extending about and interconnected with said parent part by a series of webs.

17. A method as claimed in claim 17 wherein said further comprises a step of removing said racetrack and web from said parent part.

18. A method as claimed in claim 18 wherein said method further comprises a step of grinding said racetrack in regrind and adding said regrind into said first molten material.

19. A method as claimed in claim 19 wherein said parent part has a generally convex outer surface.

20. A method as claimed in claim 20 wherein said generally convex outer surface a planar section and a flange extending about and spaced from said planar section.

21. A method as claimed in claim 21 wherein said first molten material is a thermoplastic material and said second molten material is a thermosetting resin.

22. A method as claimed in claim 22 wherein said thermoplastic material is selected from a group comprising polypropylene, polyethylene terephthalate (PET), NYLON, polycarbonate, and PCABS.

23. A method as claimed in claim 23 wherein said thermoplastic material is reinforced with a reinforcing material selected from a group comprising glass fibres, mineral fillers, and nanoparticles.

24. A mold for manufacturing a molded part having a class-A exterior surface, said mold comprising a first mold half having a peripherally extending rib and a second mold half, whereby upon closing the first mold half onto the second mold half a first mold cavity is defined with said rib extending into said first mold cavity.

25. A mold as claimed in claim 25 wherein said rib is continuous.

26. A mold as claimed in claim 25 wherein said rib is discontinuous.

27. A mold as claimed in claim 27 wherein said rib comprises a series of web portions spaced between a series of mold walls for molding a parent part and a racetrack extending about and interconnected with said parent part by a series of webs.
